(19) United States
(12) Patent Application Publication
(10) Pub. No.: US 2025/0372684 A1
(43) Pub. Date: Dec. 4, 2025

(54) ELECTROLYTE MEMBRANE INCLUDING OLIGOMERIC IONOMER AND METHOD OF PRODUCING THE SAME

(71) Applicants: Hyundai Motor Company, Seoul (KR); Kia Corporation, Seoul (KR); Industrial Cooperation Foundation Jeonbuk National University, Jeonju-si (KR)

(72) Inventors: Seong Jun Jo, Hwaseong-si (KR); Il Seok Chae, Hwaseong-si (KR); Jong Kil Oh, Hwaseong-si (KR); Sung Kon Kim, Jeonju-si (KR); Hyeong Min Park, Namwon-si (KR); Yeon Su Lee, Jeonju-si (KR)

(21) Appl. No.: 18/887,423

(22) Filed: Sep. 17, 2024

(30) Foreign Application Priority Data
May 31, 2024 (KR) 10-2024-0071264

(51) Int. Cl. H01M 8/103; H01M 8/10; H01M 8/1004; H01M 8/1032

(52) U.S. Cl. CPC H01M 8/103; H01M 8/1004; H01M 8/1032; H01M 2008/1095; H01M 2300/0082

(57) ABSTRACT

An electrolyte membrane can include a porous support and an oligomeric ionomer with which the support is impregnated, and a method of manufacturing the same. The electrolyte membrane can include a support including a reaction product of a benzimidazole-based polymer and a crosslinking agent, and an oligomeric ionomer with which the support is impregnated and containing a proton conductive group.

### CROSS-REFERENCE TO RELATED APPLICATIONS

This application claims, under 35 U.S.C. § 119(a), the benefit of priority from Korean Patent Application No. 10-2024-0071264, filed on May 31, 2024, the entire contents of which are incorporated herein by reference.

### TECHNICAL FIELD

The present disclosure relates to an electrolyte membrane including a porous support and an oligomeric ionomer with which the support is impregnated, and a method of manufacturing the same.

### BACKGROUND

A polymer electrolyte membrane fuel cell (PEMFC) is a fuel cell that uses a polymer as an electrolyte membrane. Polymer electrolyte membrane fuel cells are the most widely used due to a relatively low operating temperature and high power density and energy conversion efficiency.

Typically, a perfluorinated polymer electrolyte membrane called Nafion is mainly used, but Nafion requires constant humidity maintenance because the electrolyte membrane is hydrated and transports protons, and the manufacturing cost thereof is high.

Thorough research is ongoing into intermediate- to low-temperature fuel cell electrolyte membranes to solve moisture control problems with Nafion and achieve efficient heat management, into hydrocarbon-based polymer electrolyte membranes to reduce manufacturing costs, and into reinforced composite membranes to improve mechanical properties.

Polybenzimidazole, a hydrocarbon-based polymer electrolyte membrane, has high thermal stability, has low manufacturing cost compared to perfluorinated electrolyte membranes, and forms an acid-base complex with phosphoric acid to transfer protons, so the use thereof as electrolyte membranes for fuel cells for high temperatures exceeding 100° C. and no humidification is under active study. However, because a typical proton transfer medium such as phosphoric acid is in a monomolecular form, phosphoric acid leakage due to moisture occurs during fuel cell operation.

A reinforced composite membrane is an electrolyte membrane manufactured by impregnating a porous support having excellent mechanical properties, heat resistance, and chemical resistance with an ionomer (ion conductive polymer) responsible for transport of protons. Supports for reinforced composite membranes may be broadly classified into fluorine-based polymers and hydrocarbon-based polymers. An ePTFE/Nafion reinforced composite membrane, made by impregnating an expanded PTFE (ePTFE) support as a fluorine-based polymer with Nafion, is receiving great attention as a replacement for a conventional expensive Nafion electrolyte membrane. However, because both the support and the ionomer are fluorine-based materials, they can have the disadvantage of being expensive and requiring maintenance of high humidity.

### SUMMARY

An embodiment of the present disclosure can provide an electrolyte membrane capable of preventing leakage of an ionomer and a proton conductive functional group, and a method of manufacturing the same.

An embodiment of the present disclosure can provide an electrolyte membrane capable of maintaining high proton conductivity even in harsh environments, and a method of manufacturing the same.

An embodiment of the present disclosure can provide an electrolyte membrane with high ionomer impregnation, and a method of manufacturing the same.

Embodiments of the present disclosure are not necessarily limited to the foregoing. Embodiments of the present disclosure can be understood through the following description and can be realized by the methods and compositions described in the claims and combinations thereof.

An embodiment of the present disclosure can provide an electrolyte membrane, including a support containing a reaction product of a benzimidazole-based polymer and a crosslinking agent and an oligomeric ionomer with which the support is impregnated and containing a proton conductive group.

The support may include a urea linkage between the benzimidazole-based polymer and the crosslinking agent.

The benzimidazole-based polymer may include at least one selected from the group consisting of poly[2,2′-(m-phenylene)-5,5′-bibenzimidazole] (PBI), poly(2,5-benzimidazole) (ABPBI), and any combinations thereof.

The crosslinking agent may include at least one selected from the group consisting of methylene diphenyl diisocyanate (MDI), hexamethylene diisocyanate (HDI), and any combinations thereof.

The oligomeric ionomer may include at least one selected from the group consisting of a compound represented by Chemical Formula 1 to a compound represented by Chemical Formula 10 below, and any suitable combinations thereof.

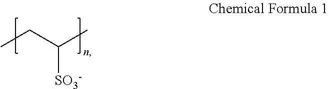

In Chemical Formula 1, n may be a number from 5 to 20.

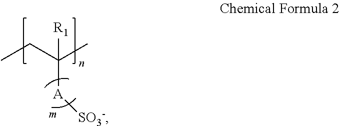

In Chemical Formula 2, R₁ may include a C1-C3 alkyl group, A may include —CH₂—, —CH₂CH₂O—, or

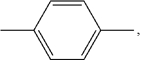

and each of m and n may be a number from 5 to 20.

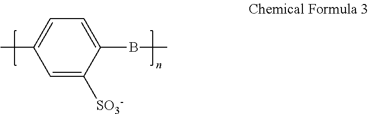

In Chemical Formula 3, B may include —S— or —SO₂—, and n may be a number from 5 to 20.

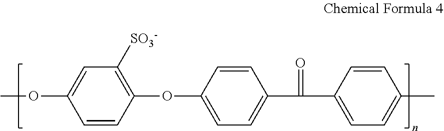

In Chemical Formula 4, n may be a number from 5 to 20.

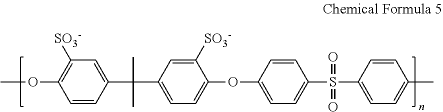

In Chemical Formula 5, n may be a number from 5 to 20.

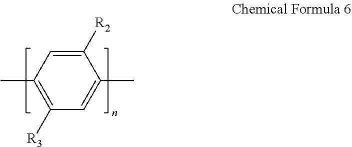

In Chemical Formula 6, R₂ and R₃ may each independently include hydrogen or —SO₃⁻, but at least one of R₂ or R₃ may include —SO₃⁻, and n may be a number from 5 to 20.

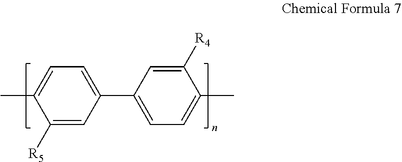

In Chemical Formula 7, R₄ and R₅ may each independently include hydrogen or —SO₃⁻, but at least one of R₄ or R₅ may include —SO₃⁻, and n may be a number from 5 to 20.

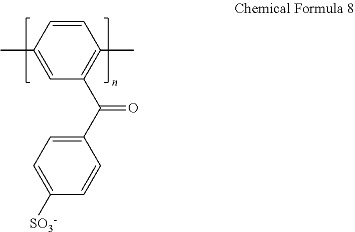

In Chemical Formula 8, n may be a number from 5 to 20.

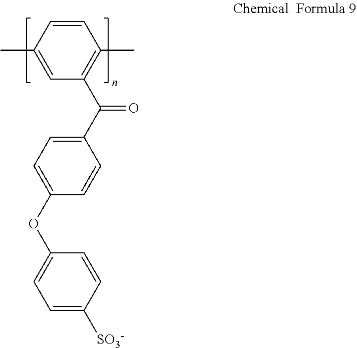

In Chemical Formula 9, n may be a number from 5 to 20.

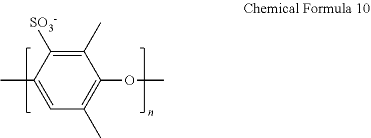

In Chemical Formula 10, n may be a number from 5 to 20.

The oligomeric ionomer may have a thermal decomposition temperature (Td) of 180° C. to 200° C. according to thermogravimetric analysis (TGA).

The electrolyte membrane may include 20 wt % to 50 wt % of the support and 50 wt % to 80 wt % of the oligomeric ionomer.

In analyzing the electrolyte membrane using scanning electron microscope-energy dispersive X-ray spectroscopy (SEM-EDS), the electrolyte membrane may have a sulfur element in an amount of 50 wt % to 60 wt %.

In analyzing the electrolyte membrane using SEM-EDS, when an integrated value of a peak of sulfur element is I_{S} and an integrated value of a peak of carbon element is I_{C}, I_{S}/I_{C} of the electrolyte membrane may be 1.5 to 2.5.

In analyzing the electrolyte membrane using SEM-EDS, when an integrated value of a peak of sulfur element is I_{S} and an integrated value of a peak of oxygen element is I_{O}, I_{S}/I_{O} of the electrolyte membrane may be 3 to 5.

The amount of leached acid depending on a pressure in the electrolyte membrane may be 3 wt % or less as measured by a weight change of an electrolyte membrane when a pressure of 1 MPa is applied to the electrolyte membrane in a thickness direction at 30° C. for 5 minutes can be as follows.

The amount of leached acid depending on a relative humidity in the electrolyte membrane may be 55 wt % or less as measured by
a weight change of an electrolyte membrane when the electrolyte membrane is exposed to an environment with a predetermined relative humidity at 30° C. for 20 minutes can be as follows.

An embodiment of the present disclosure can provide a method of manufacturing an electrolyte membrane, including preparing a crosslinked product by reacting a benzimidazole-based polymer, a nanostructure containing an imidazole group, and a crosslinking agent, obtaining a support in which the nanostructure is removed from the crosslinked product by adding a monomer containing a sulfonic acid group and the crosslinked product to a solvent, and obtaining an electrolyte membrane in which the support is impregnated with an oligomeric ionomer polymerized from the monomer by reacting the monomer.

The nanostructure may include a zeolitic imidazole framework (ZIF).

The oligomeric ionomer may be polymerized by reacting the monomer at a concentration of 1 M to 2 M in the presence of 0.1 wt % to 1 wt % of an initiator.

### BRIEF DESCRIPTION OF THE DRAWINGS

The above and other features of the present disclosure will now be described in detail referring to certain example embodiments thereof illustrated in the accompanying drawings, which are given hereinbelow by way of illustration only, and thus are not necessarily limitative of the present disclosure, and wherein:

FIG. 1 shows a fuel cell according to an embodiment of the present disclosure;

FIG. 2 shows an electrolyte membrane according to an embodiment of the present disclosure;

FIG. 3 shows results of analyzing a support according to Preparation Example 1 using a scanning electron microscope, according to an embodiment of the present disclosure;

FIG. 4 shows results of analyzing another portion of the support according to Preparation Example 1 using a scanning electron microscope, according to an embodiment of the present disclosure;

FIG. 5 shows results of analyzing an electrolyte membrane according to Comparative Preparation Example 1 using a scanning electron microscope, according to an embodiment of the present disclosure;

FIG. 6 shows results of thermogravimetric analysis (TGA) of an oligomeric ionomer according to Preparation Example 2, according to an embodiment of the present disclosure;

FIG. 7 shows results of analyzing an electrolyte membrane according to Example using a scanning electron microscope, according to an embodiment of the present disclosure;

FIG. 8 shows results of analyzing the electrolyte membrane according to Example using scanning electron microscope-energy dispersive X-ray spectroscopy (SEM-EDS);

FIG. 9 shows results of analyzing an electrolyte membrane according to Comparative Example using a scanning electron microscope, according to an embodiment of the present disclosure;

FIG. 10 shows results of analyzing the electrolyte membrane according to Comparative Example using SEM-EDS, according to an embodiment of the present disclosure;

FIG. 11 shows proton conductivity in the in-plane direction of the electrolyte membrane according to Example, according to an embodiment of the present disclosure;

FIG. 12 shows proton conductivity in the through-plane direction of the electrolyte membrane according to Example, according to an embodiment of the present disclosure;

FIG. 13 shows results of measurement of the amount of leached acid depending on the pressure in the electrolyte membranes according to Example and Comparative Example, according to an embodiment of the present disclosure; and

FIG. 14 shows results of measurement of the amount of leached acid depending on the relative humidity in the electrolyte membranes according to Example and Comparative Example, according to an embodiment of the present disclosure.

### DETAILED DESCRIPTION OF ILLUSTRATIVE EMBODIMENTS

The above and other features and advantages of the present disclosure can be more clearly understood from the following example embodiments taken in conjunction with the accompanying drawings. However, the present disclosure is not necessarily limited to the example embodiments disclosed herein, and may be modified into different forms. These example embodiments are provided to thoroughly explain the disclosure and to sufficiently transfer the spirit of the present disclosure to those skilled in the art.

Throughout the drawings, same reference numerals can refer to same or like elements. For the sake of clarity of the present disclosure, the dimensions of structures can be depicted as being larger than the actual sizes thereof.

It can be understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it can be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, numbers, values, and/or representations that express the amounts of components, reaction conditions, polymer compositions, and mixtures used herein can be taken as approximations including various uncertainties affecting measurement that inherently occur in obtaining such values, among others, and thus can be understood to be modified by the term “about” in at least some cases. Furthermore, when a numerical range is disclosed in this specification, the range can be continuous, and can include all values from the minimum value of said range to the maximum value thereof, unless otherwise indicated. Moreover, when such a range pertains to integer values, all integers including the minimum value to the maximum value can be included, unless otherwise indicated.

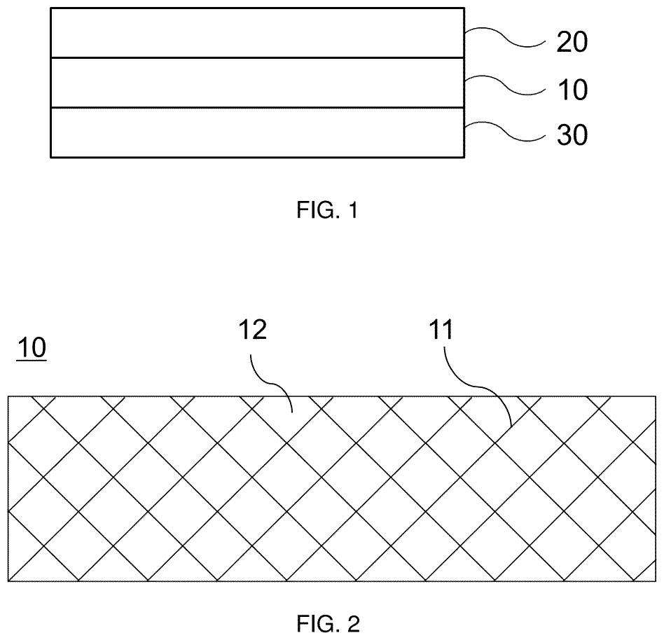

FIG. 1 shows a fuel cell according to an embodiment of the present disclosure. The fuel cell may include an electrolyte membrane 10, an anode 20 disposed on one side of the electrolyte membrane 10, and a cathode 30 disposed on the remaining side of the electrolyte membrane 10. The fuel cell may be a high-temperature polymer electrolyte membrane fuel cell (HT-PEMFC).

The high-temperature polymer electrolyte membrane fuel cell may indicate a polymer electrolyte membrane fuel cell that operates at a high temperature of about 120° C. to 200° C. Alternatively, the high-temperature polymer electrolyte membrane fuel cell may indicate a polymer electrolyte membrane fuel cell that operates at a relative humidity of about 50% or less.

The high-temperature polymer electrolyte membrane fuel cell can have the same structure or principle as a conventional low-temperature polymer electrolyte membrane fuel cell, but can have advantages such as no water flooding at the anode 20 and no need for a humidification system.

FIG. 2 shows an electrolyte membrane 10 according to an embodiment of the present disclosure. The electrolyte membrane 10 may include a support 11 and an oligomeric ionomer 12 with which the support 11 is impregnated. In FIG. 2, the support 11 is shown in a net shape, which is for explaining porous properties, and the shape of the support 11 is not necessarily limited thereto.

The support 11 may include a reaction product of a benzimidazole-based polymer and a crosslinking agent. A reaction product can refer to a result formed by chemically linking components, and can have a different meaning from a mixture or a composition.

The benzimidazole-based polymer may include at least one selected from the group consisting of poly[2,2′-(m-phenylene)-5,5′-bibenzimidazole] (PBI), poly(2,5-benzimidazole) (ABPBI), and any combinations thereof, and preferably can include poly[2,2′-(m-phenylene)-5,5′-bibenzimidazole] (PBI) represented by Structural Formula 1 below.

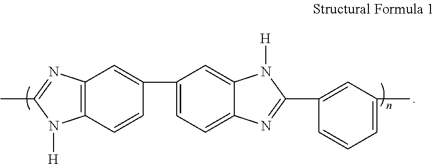

The crosslinking agent may include at least one selected from the group consisting of methylene diphenyl diisocyanate (MDI), hexamethylene diisocyanate (HDI), and combinations thereof, and preferably includes methylene diphenyl diisocyanate (MDI) represented by Structural Formula 2 below.

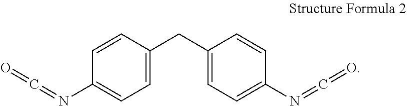 [SMILES: O=C=Nc1ccc(Cc2ccc(N=C=O)cc2)cc1]

The support 11 may include a urea linkage between a benzimidazole-based polymer and a crosslinking agent. Specifically, the urea linkage between the benzimidazole-based polymer and the crosslinking agent may be represented by Structural Formula 3 below.

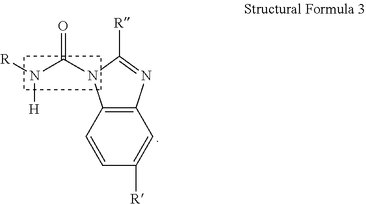

The support 11 may have a hierarchical porous structure including first pores with a larger diameter and second pores with a smaller diameter than the first pores. The first pores may be formed through a crosslinking structure of the benzimidazole-based polymer and the crosslinking agent. The second pores may be formed by removal or etching of a nanostructure, which is a kind of pore forming agent, as will be described later. Therefore, the diameter of the second pores may be the same as or similar to the diameter of the nanostructure. The diameter of the first pores may be three or more times the diameter of the second pores. For example, the first pores may have a diameter of about 300 nm to 600 nm, and the second pores may have a diameter of about 50 nm to 100 nm. The method of measuring the first pores and the second pores is not particularly limited. For example, the diameter of the first pores may be measured by observation with a scanning electron microscope (SEM). The diameter of the second pores may vary depending on the type of nanostructure. As the support 11 has a hierarchical porous structure, the amount of impregnated oligomeric ionomer 12 may increase.

The oligomeric ionomer 12 may be obtained by polymerizing a monomer with high acidity in the form of an oligomer. The acidity of the monomer is not particularly limited, but may be, for example, pH 1.0 to 3.0. When the acidity of the monomer is pH 1.0 to 3.0, the nanostructure may be appropriately removed or etched so that the support 11 may have a hierarchical porous structure including first pores and second pores. A proton transfer medium such as phosphoric acid, which is mainly used in high-temperature polymer electrolyte membrane fuel cells, is in a monomolecular form, so there is a problem of leakage due to moisture during operation. An embodiment of the present disclosure can be technically characterized in that the leakage problem can be solved using an oligomeric ionomer 12 for proton conduction. In particular, an electrolyte membrane may be formed by impregnating the basic support 11 with the oligomeric ionomer 12. The oligomeric ionomer 12 and the support 11 may form a kind of acid-base complex, more effectively preventing leaching of the oligomeric ionomer 12. Also, the oligomeric ionomer 12 may maintain high proton conductivity by virtue of the chemical structure with high acidity.

The oligomeric ionomer 12 may include at least one selected from the group consisting of a compound represented by Chemical Formula 1 to a compound represented by Chemical Formula 10 below.

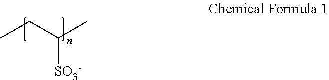

In Chemical Formula 1, n may be a number from 5 to 20.

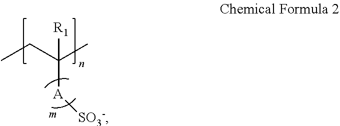

In Chemical Formula 2, R₁ may include a C1-C3 alkyl group, A may include —CH₂—, —CH₂CH₂O—, or

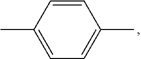

and each of m and n may be a number from 5 to 20.

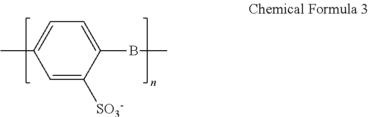

In Chemical Formula 3, B may include —S— or —SO₂—, and n may be a number from 5 to 20.

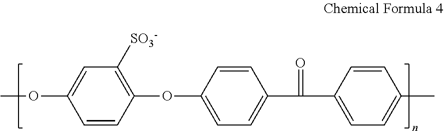

In Chemical Formula 4, n may be a number from 5 to 20.

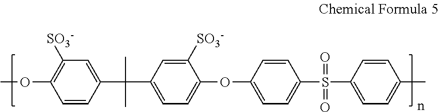

In Chemical Formula 5, n may be a number from 5 to 20.

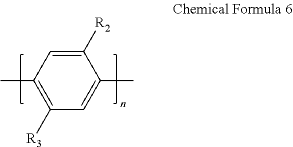

In Chemical Formula 6, R₂ and R₃ may each independently include hydrogen or —SO₃⁻, but at least one of R₂ or R₃ may include —SO₃⁻, and n may be a number from 5 to 20.

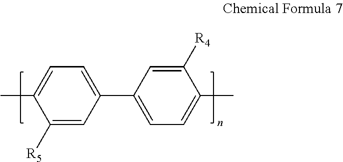

In Chemical Formula 7, R₄ and R₅ may each independently include hydrogen or —SO₃⁻, but at least one of R₄ or R₅ may include —SO₃⁻, and n may be a number from 5 to 20.

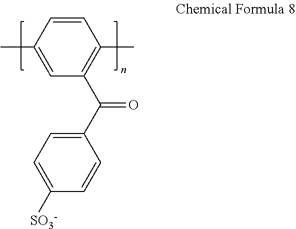

In Chemical Formula 8, n may be a number from 5 to 20.

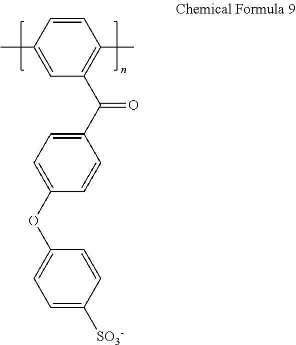

In Chemical Formula 9, n may be a number from 5 to 20.

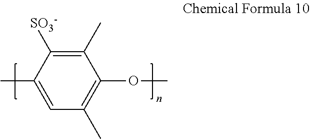

In Chemical Formula 10, n may be a number from 5 to 20.

The oligomeric ionomer 12 can include poly(vinylsulfonic acid) represented by Chemical Formula 1.

The electrolyte membrane 10 may include about 20 wt % to 50 wt % of the support 11 and about 50 wt % to 80 wt % of the oligomeric ionomer 12. If the amount of the oligomeric ionomer 12 is less than 50 wt %, the proton conductivity of the electrolyte membrane 10 may be too low, whereas if the amount thereof exceeds 80 wt %, the amount of the support 11 may be relatively low and thus the mechanical properties of the electrolyte membrane 10 may deteriorate and the acid-base complex between the oligomeric ionomer 12 and the support 11 may not be sufficiently formed, which may cause leakage of the oligomeric ionomer 12.

In addition, a method of manufacturing the electrolyte membrane 10 according to an embodiment of the present disclosure may include preparing a crosslinked product by reacting a benzimidazole-based polymer, a nanostructure containing an imidazole group, and a crosslinking agent, obtaining a support 11 in which the nanostructure is removed from the crosslinked product by adding a monomer containing a sulfonic acid group and the crosslinked product to a solvent, and obtaining an electrolyte membrane 10 in which the support 11 is impregnated with an oligomeric ionomer 12 polymerized from the monomer by reacting the monomer. Obtaining the support 11 and obtaining the electrolyte membrane 10 may occur simultaneously.

A method of manufacturing the electrolyte membrane 10 according to an embodiment of the present disclosure may include preparing a crosslinked product by reacting a benzimidazole-based polymer, a nanostructure containing an imidazole group, and a crosslinking agent, preparing an oligomeric ionomer 12 by adding a monomer containing a sulfonic acid group to a solvent and reacting the monomer, and mixing the crosslinked product with the oligomeric ionomer 12 to form a support in which the nanostructure is removed from the crosslinked product and simultaneously impregnating the support 11 with the oligomeric ionomer 12.

The nanostructure containing the imidazole group may include, as a kind of pore forming agent, a zeolitic imidazole framework (ZIF), preferably ZIF-8 represented by Structural Formula 4 below.

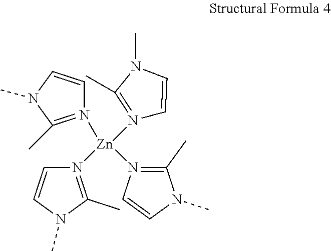

Within the crosslinked product, the nanostructure and the crosslinking agent may form a urea linkage represented by Structural Formula 5 below.

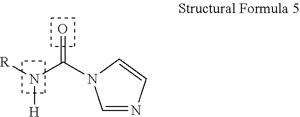

In preparing the crosslinked product, the benzimidazole-based polymer and the crosslinking agent may be mixed at a weight ratio of about 99:1 to 50:50. The amount of the crosslinking agent can be about 20 wt % or less based on the combined total weight of the benzimidazole-based polymer and the crosslinking agent. If the amount of the crosslinking agent exceeds 20 wt %, agglomeration may occur due to self-linkage, which can make it difficult to manufacture the crosslinked product in the form of a film.

In preparing the crosslinked product, the benzimidazole-based polymer and the nanostructure may be mixed at a weight ratio of about 99:1 to 50:50. The amount of the nanostructure may be about 10 wt % or less based on the combined total weight of the benzimidazole-based polymer and the nanostructure. If the amount of the nanostructure exceeds 10 wt %, the second pores may be excessively formed, interfering with the formation of the support 11 or making it difficult for the support 11 to maintain the shape thereof.

In preparing the crosslinked product, a catalyst may be further added in addition to the components. The catalyst can be conventionally known and is not particularly limited. For example, the catalyst may include at least one selected from among amine-based catalysts such as triethylamine (TEA), tripropylamine, polyisopropanolamine, tributylamine, trioctylamine, hexamethyldimethylamine, N-methylmorpholine, N-ethylmorpholine, N-octadecylmorpholine, monoethanolamine, diethanolamine, triethanolamine, N-methyldiethanolamine, N,N-dimethylethanolamine, diethylenetriamine, N,N,N′,N′-tetramethylethylenediamine, N,N,N′,N′-tetramethylpropylenediamine, N,N,N′,N′-tetramethylbutanediamine, N,N,N′,N′-tetramethyl-1,3-butanediamine, N,N,N′,N′-tetramethylhexamethylenediamine, bis[2-(N,N-dimethylamino)ethyl ether, N,N-dimethylbenzylamine, N,N-dimethylcyclohexyl amine, N,N,N′,N′-pentamethyldiethylenetriamine, and triethylenediamine.

As described above, the monomer can have a high acidity of pH 1.0 to 3.0, and thus, when the monomer and the crosslinked product are mixed, the nanostructure in the crosslinked product may be removed or etched to obtain a support including first pores and second pores.

For the oligomeric ionomer 12, the monomer containing a sulfonic acid group may be formed into an oligomer by free radical reaction. An initiator may be used for free radical reaction. The type of initiator is not particularly limited and may include, for example, ammonium persulfate (APS).

For example, the oligomeric ionomer 12 represented by Chemical Formula 1 may be prepared according to Scheme 1 below.

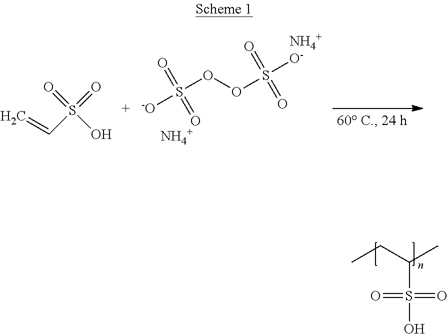

In Scheme 1, vinylsulfonic acid, a monomer containing a sulfonic acid group, can be subjected to free radical reaction by radicals generated by ammonium persulfate (APS) as an initiator, whereby polyvinylsulfonic acid in the form of an oligomer can be synthesized.

The oligomeric ionomer 12 represented by each of Chemical Formula 2 to Chemical Formula 10 may also be synthesized using an appropriate monomer.

For example, the oligomeric ionomer 12 represented by Chemical Formula 3 may be prepared according to Scheme 2 below.

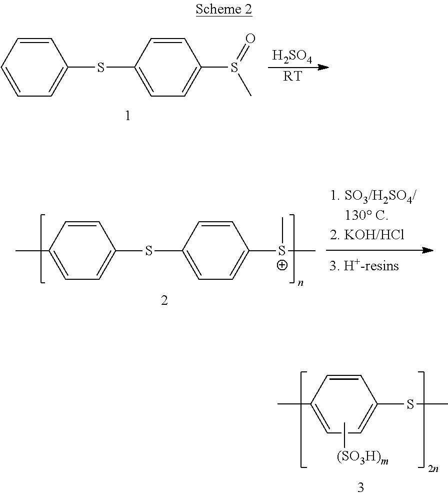

A monomer, 4-(methylsulfinyl)diphenyl sulfide 1 (in Scheme 2), may be added to a reactor, sulfuric acid may be added to the reactor under a nitrogen atmosphere and reacted, ethanol may be added to form a precipitate, and the precipitate may be dried, obtaining poly(methylsulfonio-1,4-phenylenethio-1,4-phenylene hydrogen sulfate) 2 (Scheme 2). The poly(methylsulfonio-1,4-phenylenethio-1,4-phenylene hydrogen sulfate) may be added to the reactor, and SO₃-sulfuric acid at a concentration of 10% may be added dropwise to the reactor under a nitrogen atmosphere. After reaction of the mixture by heating to a predetermined temperature and stirring, ethanol may be added to form a precipitate, and the precipitate may be washed and dried. The result may be washed with potassium chloride and potassium hydroxide, yielding poly(thio-1,4-phenylenesulfonic acid) 3 (in Scheme 2).

A manufacturing method of an embodiment may further include drying the electrolyte membrane 10 manufactured as above.

A better understanding of the present disclosure may be obtained through the following examples (example embodiments). These examples are merely set forth to illustrate the present disclosure and are not to be construed as limiting the scope of the present disclosure.

### Preparation Example 1—Preparation of Support

5 g of a solution of a benzimidazole-based polymer dissolved at 10 wt % in an organic solvent, 0.5 g of a solution of a crosslinking agent dissolved at 10 wt % in the same organic solvent, 0.15 g of a solution of a nanostructure containing an imidazole group dissolved at 10 wt % in the same organic solvent, and 1 ml of a catalyst were added to a vial and stirred at room temperature for 3 hours.

The stirred solution was cast on a substrate, dried at 80° C. for 3 hours, and heat-treated at 120° C. for 21 hours, thereby manufacturing a film-type support through a crosslinking process.

The benzimidazole-based polymer was poly[2,2′-(m-phenylene)-5,5′-bibenzimidazole] (PBI), the crosslinking agent was methylene diphenyl diisocyanate (MDI), the nanostructure was ZIF-8, the organic solvent was dimethylacetamide (DMAc), and the catalyst was triethylamine (TEA).

The support was washed several times with distilled water and then dried again.

### Comparative Preparation Example 1

A polybenzimidazole-based electrolyte membrane used in a conventional high-temperature polymer electrolyte membrane fuel cell was set as Comparative Preparation Example.

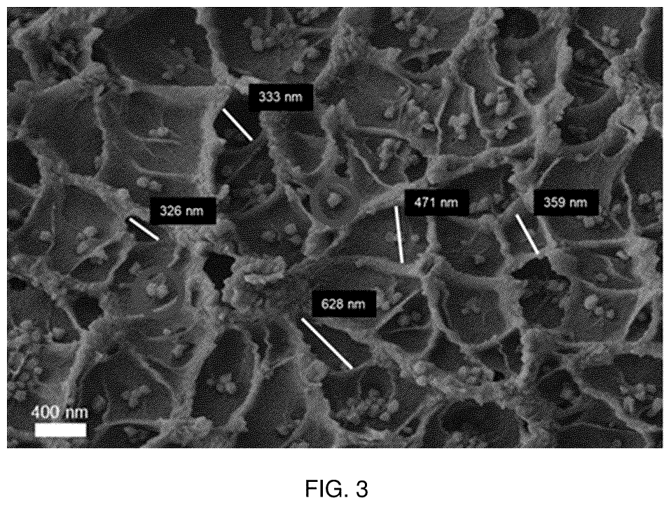

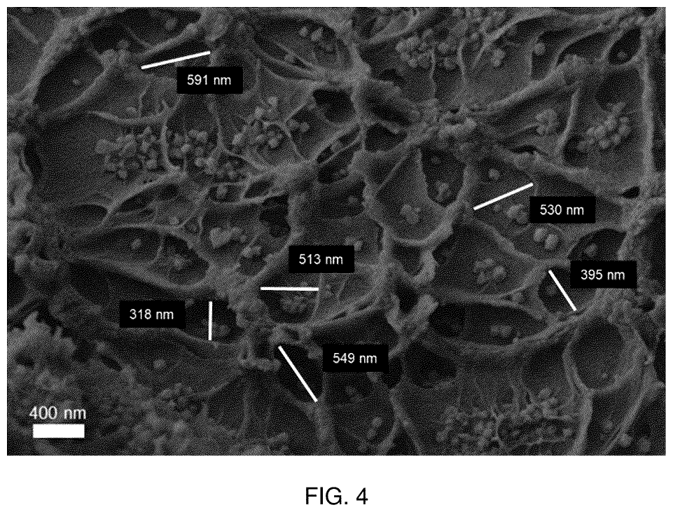

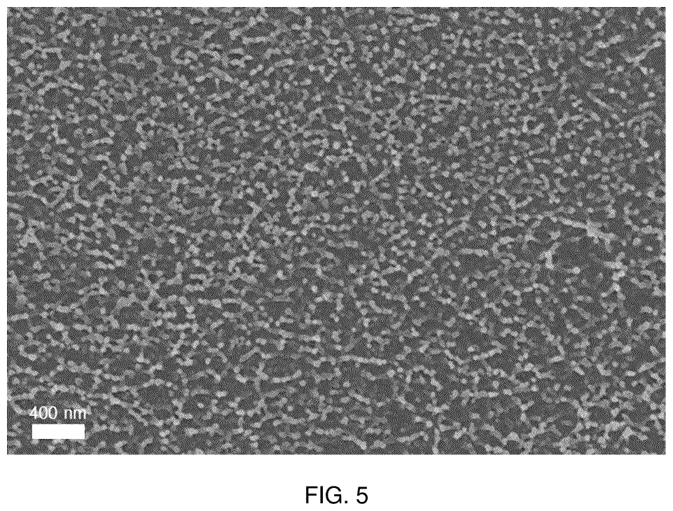

FIG. 3 shows results of analyzing the support according to Preparation Example 1 using a scanning electron microscope. FIG. 4 shows results of analyzing another portion of the support according to Preparation Example 1 using a scanning electron microscope. FIG. 5 shows results of analyzing the electrolyte membrane according to Comparative Preparation Example 1 using a scanning electron microscope. Referring to FIG. 5, there were no pores in the electrolyte membrane of Comparative Preparation Example 1. Referring to FIGS. 3 and 4, the support according to Preparation Example 1 includes first pores having a diameter of 300 nm to 600 nm. Also, the nanostructure is indicated by circular marks in FIG. 3, and when a monomer or oligomeric ionomer is added to impregnate the support with the oligomeric ionomer, the nanostructure may be removed or etched to form second pores in the support. Thereby, it can be found that the support according to the present disclosure has a hierarchical porous structure in which first pores and second pores with a smaller diameter than the first pores are formed.

### Preparation Examples 2 to 4 and Comparative Preparation Examples 2 to 4—Preparation of Oligomeric Ionomer

Vinylsulfonic acid (VSA), a monomer containing a sulfonic acid group, was dissolved in water along with ammonium persulfate (APS) as an initiator, and reacted at about 60° C. for 24 hours. The concentration of vinylsulfonic acid was 1 M and 4 M, and the amount of initiator was adjusted to 0.1 wt % to 1 wt % based on the combined total weight of vinylsulfonic acid and initiator. After completion of reaction, drying was performed in a vacuum oven for about 48 hours, yielding an oligomeric ionomer.

The proton conductivity of each oligomeric ionomer was measured, and the results thereof are shown in Table 1 below.

TABLE 1

| | Concen- | Amount of | Proton |
|---|---|---|---|
| | tration of | initiator | conductivity |
| Classification | VSA | [wt %] | [S · cm⁻¹ @ 20° C.] |
| Preparation Example 2 | 1M | 0.1 | 6.37 × 10⁻⁵ |
| Preparation Example 3 | | 0.5 | 5.00 × 10⁻⁵ |
| Preparation Example 4 | | 1.0 | 4.96 × 10⁻⁵ |
| Comparative Preparation | 4M | 0.1 | 2.78 × 10⁻⁵ |
| Example 2 | | | |
| Comparative Preparation | | 0.5 | 4.51 × 10⁻⁸ |
| Example 3 | | | |
| Comparative Preparation | | 1.0 | 1.89 × 10⁻⁷ |
| Example 4 | | | |

When comparing Preparation Example 2 with Comparative Preparation Example 2, Preparation Example 3 with Comparative Preparation Example 3, and Preparation Example 4 with Comparative Preparation Example 4, the proton conductivity is higher when the concentration of VSA is 1 M than when the concentration of VSA is 4 M. Comparative Preparation Examples 2 to 4 show low proton conductivity because synthesis of the oligomeric ionomer is hindered due to the high concentration of VSA.

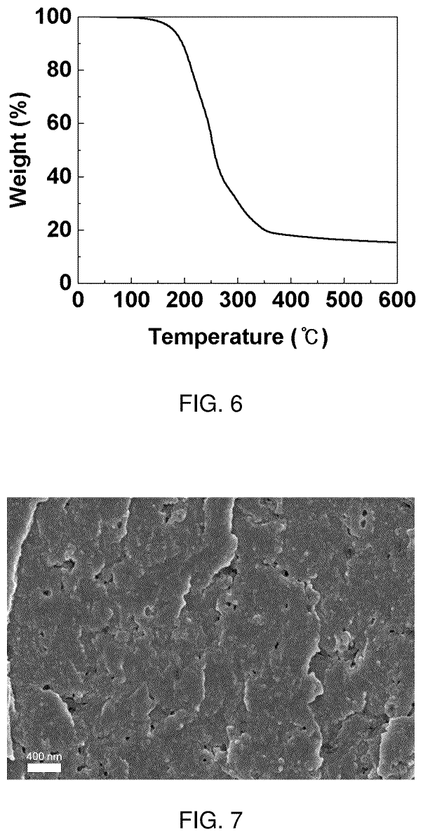

FIG. 6 shows results of thermogravimetric analysis (TGA) of the oligomeric ionomer according to Preparation Example 2. The thermogravimetric analysis was conducted according to ISO 11358-1 (2022). With reference thereto, the oligomeric ionomer began to decompose at about 183.2° C. The oligomeric ionomer according to the present disclosure had a thermal decomposition temperature (Td) of 180° C. to 200° C. and exhibited excellent thermal stability at 120° C. to 200° C., which is the operating temperature of a high-temperature polymer electrolyte membrane fuel cell.

### EXAMPLE

The support according to Preparation Example 1, vinylsulfonic acid (VSA) as a monomer containing a sulfonic acid group, and ammonium persulfate (APS) as an initiator were dissolved in water and stirred at 100 rpm at about 60° C. for 4 hours to react the monomer. Then, the result was dried in an oven at about 60° C. for about 20 hours and stored in a vacuum oven at room temperature for about 12 hours, thereby manufacturing an electrolyte membrane in which the support was impregnated with an oligomeric ionomer. The amount of impregnated oligomeric ionomer was about 71 wt % based on the total weight of the electrolyte membrane.

### Comparative Example

An electrolyte membrane was manufactured in the same manner as in Example above, with the exception that the electrolyte membrane according to Comparative Preparation Example 1 was used as a support.

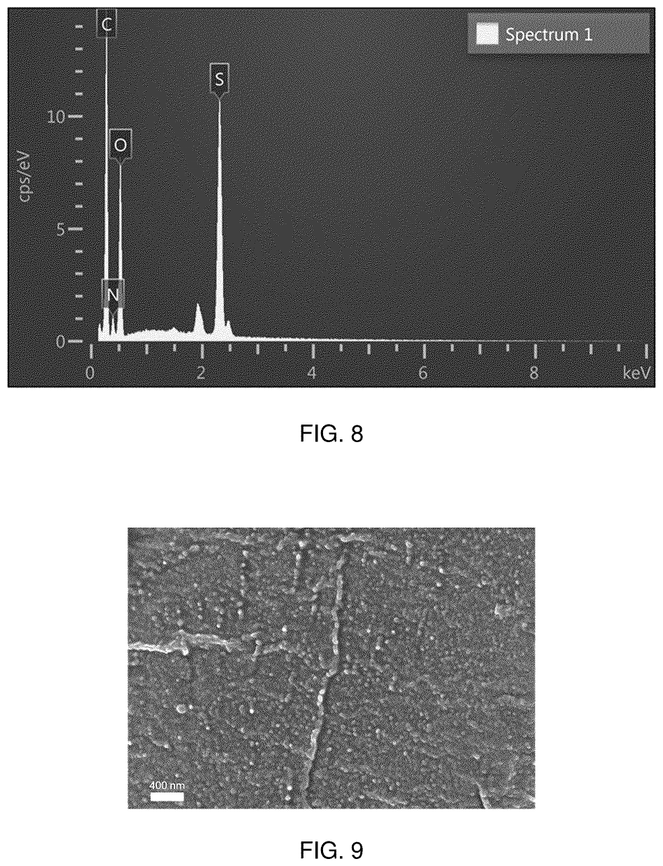

FIG. 7 shows results of analyzing the electrolyte membrane according to Example using a scanning electron microscope. FIG. 8 shows results of analyzing the electrolyte membrane according to Example using SEM-EDS (scanning electron microscope-energy dispersive X-ray spectroscopy).

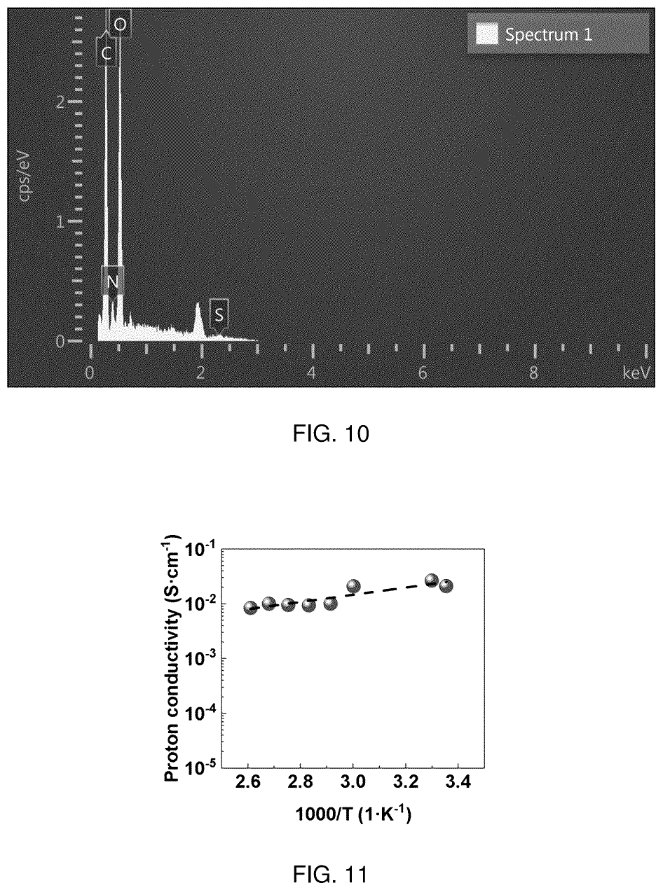

FIG. 9 shows results of analyzing the electrolyte membrane according to Comparative Example using a scanning electron microscope. FIG. 10 shows results of analyzing the electrolyte membrane according to Comparative Example using SEM-EDS.

Referring to FIG. 7, in the electrolyte membrane according to the present disclosure, the pores of the support were completely filled with the oligomeric ionomer without any empty space.

Referring to FIGS. 8 and 10, based on the results of analysis by SEM-EDS, the electrolyte membrane according to Example was well impregnated with the oligomeric ionomer because a peak due to sulfur was observed, whereas the electrolyte membrane according to Comparative Example was not impregnated with the oligomeric ionomer because no peak due to sulfur was observed.

Based on the results of FIGS. 8 and 10, the contents of constituent elements of the electrolyte membranes according to Example and Comparative Example are shown in Table 2 below.

TABLE 2

| Classification | Carbon (C) | Oxygen (O) | | Nitrogen (N) | Sulfur (S) | | Total |
|---|---|---|---|---|---|---|---|
| Comparative Example | 44.64 wt % | 48.53 | wt % | 6.83 wt % | 0 | wt % | 100 wt % |
| Example | 27.59 wt % | 14 | wt % | 2.54 wt % | 55.87 | wt % | 100 wt % |

Referring to Table 2, when analyzing the electrolyte membrane according to an embodiment of the present disclosure using SEM-EDS, the electrolyte membrane may have a sulfur element in an amount of 10 wt % to 60 wt %, 20 wt % to 60 wt %, 30 wt % to 60 wt %, 40 wt % to 60 wt %, or 50 wt % to 60 wt %. Mapping analysis using SEM-EDS was performed under conditions of vacuum of 5×10⁻⁷ mbar or less, room temperature, 5 kV, LED, and WD of 10.9 mm. If the content of the sulfur element is less than 10 wt %, the amount of the impregnated oligomeric ionomer may not be sufficient, and thus proton conductivity of the electrolyte membrane may decrease and the amount of leached acid may increase.

In addition, when the integrated value of the peak of sulfur element is I_{S} and the integrated value of the peak of carbon element is I_{C}, I_{S}/I_{C} of the electrolyte membrane may be 1.5 to 2.5, and when the integrated value of the peak of sulfur element is I_{S} and the integrated value of the peak of oxygen element is I_{O}, I_{S}/I_{O} of the electrolyte membrane may be 3 to 5. When the results of SEM-EDS fall within the above numerical ranges, the support is regarded as well impregnated with the oligomeric ionomer.

The proton conductivity of the electrolyte membrane according to Example in the in-plane direction and through-plane direction was measured. The proton conductivity was measured under conditions of 30° C. to 110° C. and no humidification.

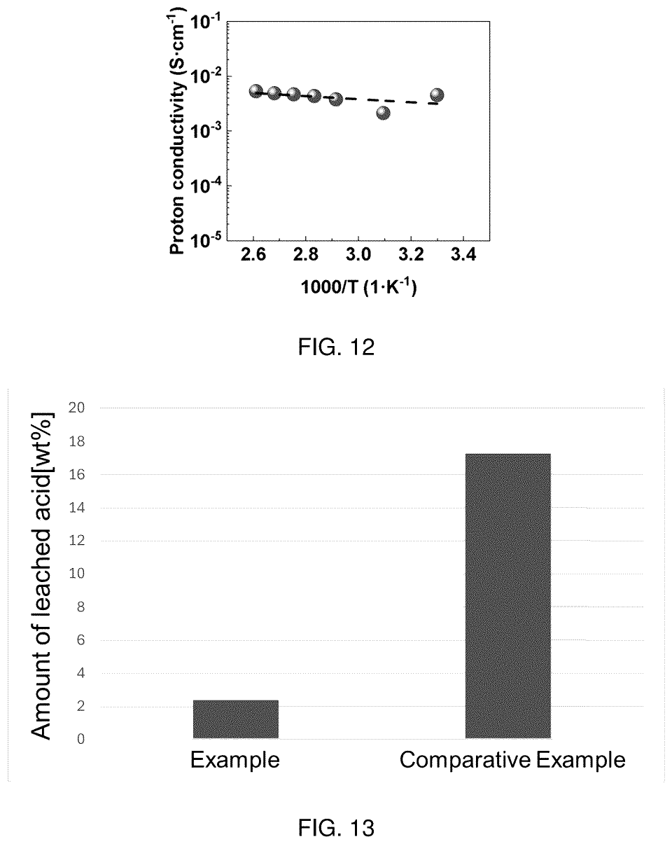

FIG. 11 shows the proton conductivity in the in-plane direction of the electrolyte membrane according to Example. FIG. 12 shows the proton conductivity in the through-plane direction of the electrolyte membrane according to Example. The proton conductivity in the in-plane direction of the electrolyte membrane is about 2.1×10⁻² S/cm at room temperature and about 8.4×10⁻³ S/cm at 110° C. The proton conductivity in the through-plane direction of the electrolyte membrane is about 4.5×10⁻³ S/cm at room temperature and about 5.3×10⁻³ S/cm at 110° C.

The amount of leached acid depending on the pressure in the electrolyte membrane according to each of Example and Comparative Example was measured. When a pressure of about 1 MPa was applied to each electrolyte membrane in the thickness direction at about 30° C. for 5 minutes, the amount of leached acid was determined by measuring a weight change of the electrolyte membrane. The weight change was calculated as {(weight before test−weight after test)/weight before test}×100. The results thereof are shown in FIG. 13. Referring thereto, the amount of leached acid depending on the pressure in the electrolyte membrane according to Example was very low to the level of about 3 wt % or less, as measured under the test conditions described above. In contrast, the electrolyte membrane according to Comparative Example had a very serious leaching problem, in which the amount of leached acid depending on the pressure was 17 wt % or more.

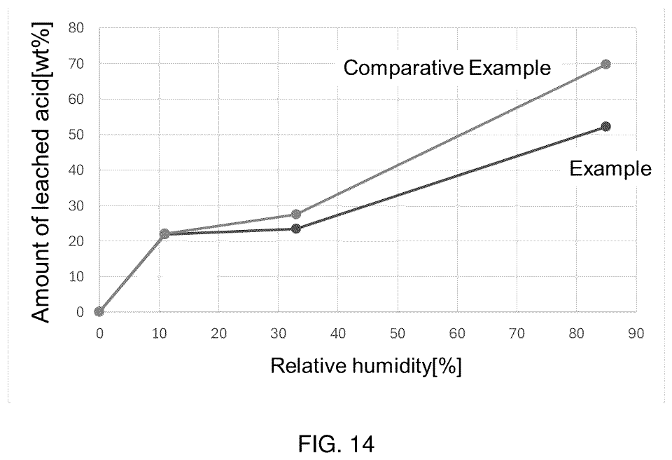

The amount of leached acid depending on the relative humidity in the electrolyte membrane according to each of Example and Comparative Example was measured. When each electrolyte membrane was exposed to an environment with a specific relative humidity of 10% to 85% at about 30° C. for 20 minutes, the amount of leached acid was determined by measuring a weight change of the electrolyte membrane. The weight change was calculated in the same way as above. The results thereof are shown in FIG. 14. Referring thereto, the electrolyte membrane according to Example exhibited about 25 wt % or less of leached acid at a relative humidity of about 30%, and about 55 wt % or less of leached acid at a relative humidity of about 85%. The electrolyte membrane according to Comparative Example exhibited about 70 wt % of leached acid at a relative humidity of about 85%. The electrolyte membrane according to the present disclosure showed that the leaching of the proton conduction medium was significantly reduced compared to the conventional electrolyte membrane.

As can be apparent from the above description, according to an embodiment of the present disclosure, an electrolyte membrane capable of preventing leakage of an ionomer and a proton conductive functional group and a method of manufacturing the same can be provided.

According to an embodiment of the present disclosure, an electrolyte membrane capable of maintaining high proton conductivity even in harsh environments and a method of manufacturing the same can be provided.

According to an embodiment of the present disclosure, an electrolyte membrane with high ionomer impregnation and a method of manufacturing the same can be provided.

The advantages of the example embodiments of the present disclosure are not necessarily limited to the foregoing. It can be understood that advantages of embodiments of the present disclosure can include any and all that can be inferred from the description of the example embodiments of the present disclosure.

Although specific example embodiments of the present disclosure have been described with reference to the accompanying drawings, those skilled in the art can appreciate that the present disclosure may be embodied in other specific forms without changing the technical spirit or essential features thereof. Thus, the example embodiments described above can be understood to be non-limiting and illustrative.

What is claimed is:

1. An electrolyte membrane, comprising:
a support comprising a reaction product of a benzimidazole-based polymer and a crosslinking agent; and
an oligomeric ionomer formed in the support, the oligomeric ionomer comprising a proton conductive group.

2. The electrolyte membrane of claim 1, wherein the support comprises a urea linkage between the benzimidazole-based polymer and the crosslinking agent.

3. The electrolyte membrane of claim 1, wherein the benzimidazole-based polymer comprises at least one selected from the group consisting of poly[2,2′-(m-phenylene)-5,5′-bibenzimidazole] (PBI), poly(2,5-benzimidazole) (ABPBI), and any combinations thereof.

4. The electrolyte membrane of claim 1, wherein the crosslinking agent comprises at least one selected from the group consisting of methylene diphenyl diisocyanate (MDI), hexamethylene diisocyanate (HDI), and any combinations thereof.

5. The electrolyte membrane of claim 1, wherein the support comprises:
first pores having a first pore diameter of 300 nm to 600 nm; and
second pores having a second pore diameter of 50 nm to 100 nm.

6. The electrolyte membrane of claim 1, wherein the oligomeric ionomer comprises at least one selected from the group consisting of a first compound represented by a Chemical Formula 1, a second compound represented by a Chemical Formula 2, a third compound represented by a Chemical Formula 3, a fourth compound represented by a Chemical Formula 4, a fifth compound represented by a Chemical Formula 5, a six compound represented by a Chemical Formula 6, a seventh compound represented by a Chemical Formula 7, an eighth compound represented by a Chemical Formula 8, a ninth compound represented by a Chemical Formula 9, and a tenth compound represented by a Chemical Formula 10, wherein:
wherein the Chemical Formula 1 is 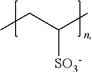
wherein in the Chemical Formula 1, n is a number from 5 to 20;
wherein the Chemical Formula 2 is 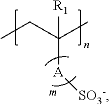
wherein in the Chemical Formula 2, R₁ comprises a C1-C3 alkyl group, A comprises —CH2-, —CH2CH2O—, or 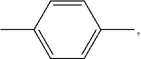
and each of m and n is a number from 5 to 20;
wherein the Chemical Formula 3 is 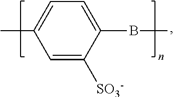
wherein in the Chemical Formula 3, B comprises —S— or —SO2-, and
n is a number from 5 to 20;
wherein the Chemical Formula 4 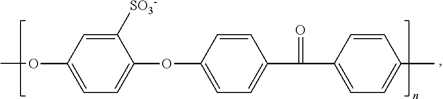
wherein in the Chemical Formula 4, n is a number from 5 to 20;
wherein the Chemical Formula 5 is 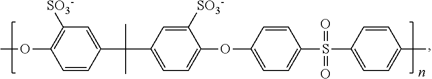
wherein in the Chemical Formula 5, n is a number from 5 to 20;
wherein the Chemical Formula 6 is 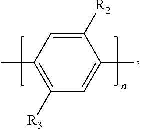
wherein in the Chemical Formula 6, R2 and R3 each independently comprise hydrogen or —SO3, but at least one of R2 or R3 comprises —SO3-, and
n is a number from 5 to 20;
wherein the Chemical Formula 7 is 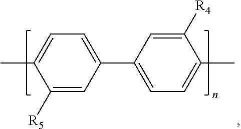
wherein in Chemical Formula 7, R4 and R5 each independently comprise hydrogen or —SO3-, but at least one of R4 or R5 comprises —SO3-, and
n is a number from 5 to 20;
wherein the Chemical Formula 8 is 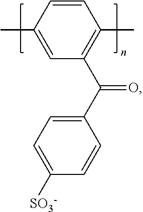
wherein in Chemical Formula 8, n is a number from 5 to 20;
the Chemical Formula 9 is 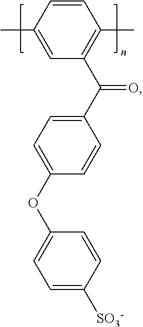
wherein in Chemical Formula 9, n is a number from 5 to 20; and
the Chemical Formula 10 is 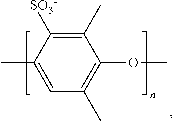
wherein in Chemical Formula 10, n is a number from 5 to 20.

7. The electrolyte membrane of claim 1, wherein the oligomeric ionomer has a thermal decomposition temperature of 180° C. to 200° C. according to thermogravimetric analysis.

8. The electrolyte membrane of claim 1, wherein the electrolyte membrane comprises:
20 wt % to 50 wt % of the support; and
50 wt % to 80 wt % of the oligomeric ionomer.

9. The electrolyte membrane of claim 1, wherein, in analyzing the electrolyte membrane using scanning electron microscope-energy dispersive X-ray spectroscopy, the electrolyte membrane has a sulfur element in an amount of 50 wt % to 60 wt %.

10. The electrolyte membrane of claim 1, wherein, in analyzing the electrolyte membrane using scanning electron microscope-energy dispersive X-ray spectroscopy, with an integrated value of a peak of sulfur element being IS and an integrated value of a peak of carbon element being IC, IS/IC of the electrolyte membrane is 1.5 to 2.5.

11. The electrolyte membrane of claim 1, wherein, in analyzing the electrolyte membrane using scanning electron microscope-energy dispersive X-ray spectroscopy, with an integrated value of a peak of sulfur element being IS and an integrated value of a peak of oxygen element being IO, IS/IO of the electrolyte membrane is 3 to 5.

12. The electrolyte membrane of claim 1, wherein an amount of leached acid depending on a pressure in the electrolyte membrane is 3 wt % or less as measured by a weight change of the electrolyte membrane with pressure of 1 MPa being applied to the electrolyte membrane in a thickness direction at 30° C. for 5 minutes.

13. The electrolyte membrane of claim 1, wherein an amount of leached acid depending on a relative humidity in the electrolyte membrane is 55 wt % or less as measured by a weight change of the electrolyte membrane with the electrolyte membrane being exposed to an environment with relative humidity at 30° C. for 20 minutes.

14. A fuel cell, comprising:
an electrolyte membrane including a support and an oligomeric ionomer, wherein the support comprises a reaction product of a benzimidazole-based polymer and a crosslinking agent, and wherein the oligomeric ionomer is formed in the support and the oligomeric ionomer comprises a proton conductive group;
an anode disposed on a first side of the electrolyte membrane; and
a cathode disposed on a second side of the electrolyte membrane, wherein the first side is opposite the second side.

15. A method of manufacturing an electrolyte membrane, comprising:
preparing a crosslinked product by reacting a benzimidazole-based polymer, a nanostructure comprising an imidazole group, and a crosslinking agent;
obtaining a support in which the nanostructure is removed from the crosslinked product by adding a monomer comprising a sulfonic acid group and the crosslinked product to a solvent; and
obtaining the electrolyte membrane in which the support is impregnated with an oligomeric ionomer polymerized from the monomer by reacting the monomer.

16. The method of claim 15, wherein the nanostructure comprises a zeolitic imidazole framework.

17. The method of claim 15, wherein the support comprises:
first pores having a first pore diameter of 300 nm to 600 nm; and
second pores having a second pore diameter of 50 nm to 100 nm.

18. The method of claim 15, wherein the oligomeric ionomer is polymerized by reacting the monomer at a concentration of 1 M to 2 M in presence of 0.1 wt % to 1 wt % of an initiator.

19. The method of claim 15, wherein the oligomeric ionomer comprises at least one selected from the group consisting of a first compound represented by a Chemical Formula 1, a second compound represented by a Chemical Formula 2, a third compound represented by a Chemical Formula 3, a fourth compound represented by a Chemical Formula 4, a fifth compound represented by a Chemical Formula 5, a six compound represented by a Chemical Formula 6, a seventh compound represented by a Chemical Formula 7, an eighth compound represented by a Chemical Formula 8, a ninth compound represented by a Chemical Formula 9, and a tenth compound represented by a Chemical Formula 10, wherein:
wherein the Chemical Formula 1 is 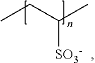
wherein in the Chemical Formula 1, n is a number from 5 to 20;
wherein the Chemical Formula 2 is 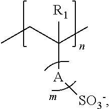
wherein in the Chemical Formula 2, R1 comprises a C1-C3 alkyl group,
wherein A comprises —CH2-, —CH2CH2O—, or 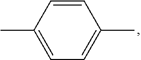
and each of m and n is a number from 5 to 20;
wherein the Chemical Formula 3 is 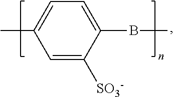
wherein in the Chemical Formula 3, B comprises —S— or —SO2-, and n is a number from 5 to 20;
wherein the Chemical Formula 4 is 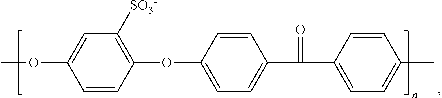
wherein in the Chemical Formula 4, n is a number from 5 to 20;
wherein the Chemical Formula 5 is 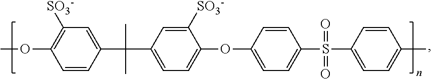
wherein in the Chemical Formula 5, n is a number from 5 to 20;
wherein the Chemical Formula 6 is 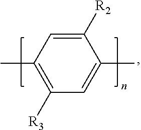
wherein in the Chemical Formula 6, R2 and R3 each independently comprise hydrogen or —SO3-, but at least one of R2 or R3 comprises —SO3-, and n is a number from 5 to 20;
wherein the Chemical Formula 7 is 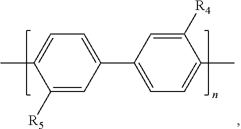
wherein in Chemical Formula 7, R4 and R5 each independently comprise hydrogen or —SO3-, but at least one of R4 or R5 comprises —SO3-, and n is a number from 5 to 20;
wherein the Chemical Formula 8 is 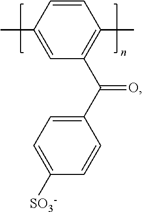
wherein in Chemical Formula 8, n is a number from 5 to 20;
wherein the Chemical Formula 9 is 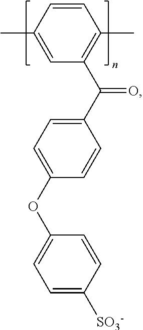
wherein in Chemical Formula 9, n is a number from 5 to 20; and wherein the Chemical Formula 10 is 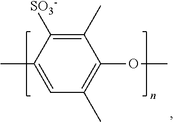
wherein in Chemical Formula 10, n is a number from 5 to 20.

20. The method of claim 15, wherein the electrolyte membrane comprises:
20 wt % to 50 wt % of the support; and
50 wt % to 80 wt % of the oligomeric ionomer.
